(19) United States
(12) Patent Application Publication
(10) Pub. No.: US 2015/0054919 A1
(43) Pub. Date: Feb. 26, 2015

(54) THREE-DIMENSIONAL IMAGE SENSOR MODULE AND METHOD OF GENERATING THREE-DIMENSIONAL IMAGE USING THE SAME

(71) Applicant: SK hynix Inc., Gyeonggi-do (KR)

(72) Inventors: Sang-Sik KIM, Gyeonggi-do (KR); Hong-Sung LIM, Gyeonggi-do (KR); Won-Jin KIM, Gyeonggi-do (KR)

(73) Assignee: SK hynix Inc., Gyeonggi-do (KR)

(21) Appl. No.: 14/200,489

(22) Filed: Mar. 7, 2014

(30) Foreign Application Priority Data
Aug. 22, 2013 (KR) 10-2013-0099802

(51) Int. Cl. H04N 13/02; H04N 5/33

(52) U.S. Cl. CPC H04N 13/0203; H04N 5/33
USPC 348/46

(57) ABSTRACT

A 3D image sensor module includes an image sensor including a plurality of color pixels and a plurality of infrared pixels, and a variable filter suitable for selectively filtering visible rays or infrared rays from light, which is incident on the image sensor, in a time-division way.

### CROSS-REFERENCE TO RELATED APPLICATION

The present application claims priority of Korean Patent Application No. 10-2013-0099802, filed on Aug. 22, 2013, which is incorporated herein by reference in its entirety.

### BACKGROUND

1. Field

Exemplary embodiments of the present invention relate to image signal processing technology, and more particularly, to a three-dimensional (3D) image sensor module and a method of generating a 3D image using the same.

2. Description of the Related Art

An image sensor is an apparatus for converting an optical signal, including information on an image and distance (or depth) of a subject for photography, into an electrical signal. In general, two-dimensional (2D) image information may be obtained by an image sensor, but research and development are recently carried out to implement a 3D image by adding distance information to 2D image information.

### SUMMARY

Various embodiments of the present invention are directed to a 3D image sensor module that may provide a high-quality 3D image and a method of generating a 3D image using the same.

In accordance with an embodiment of the present invention, a 3D image sensor module may include an image sensor including a plurality of color pixels and a plurality of infrared pixels, and a variable filter suitable for filtering visible rays or infrared ray from light, which is incident on the image sensor, in a time-division way.

In accordance with another embodiment of the present invention, a 3D image sensor module may include an image sensor including a plurality of color pixels and a plurality of infrared pixels, and a variable filter including a first filtering unit suitable for filtering out infrared rays from a incident light, a second filtering unit suitable for filtering out visible rays from the incident light, and a driving unit suitable for selectively and sequentially placing the first filtering unit and the second filtering unit over the image sensor.

In accordance with yet another embodiment of the present invention, a method of generating a 3D image using a variable filter including a first filtering unit suitable for filtering out infrared rays from a incident light and a second filtering unit suitable for filtering out visible rays from the incident light, may include: placing the first filtering unit over the image sensor, obtaining image information on a subject for photography by using the incident light filtered through the first filtering unit, placing the second filtering unit over the image sensor, and, obtaining distance information on the subject for photography by using the incident light filtered through the second filter.

### BRIEF DESCRIPTION OF THE DRAWINGS

FIGS. 1A and 1B are diagrams showing a 3D image sensor module in accordance with an embodiment of the present invention.

FIG. 2 is a perspective view illustrating a modified embodiment of the 3D image sensor module.

FIGS. 3A and 3B are diagrams showing an image sensor in accordance with an embodiment of the present invention.

FIG. 4 is a flowchart illustrating a method of generating a 3D image in accordance with the embodiment of the present invention.

FIGS. 5 and 6 are diagrams showing an image processing system including a 3D image sensor module in accordance with the embodiment of the present invention.

### DETAILED DESCRIPTION

Exemplary embodiments of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention.

The drawings are not necessarily to scale and in some instances, proportions may have been exaggerated to clearly illustrate features of the embodiments. When a first layer is referred to as being “on” a second layer or “on” a substrate, it not only refers to a case where the first layer is formed directly on the second layer or the substrate but also a case where a third layer exists between the first layer and the second layer or the substrate.

Prior to a description of embodiments of the present invention, in general, it has been known that a 3D image may be implemented by adding distance information, which is obtained using infrared rays (or near-infrared rays), to 2D image information (or color information). It may be, however, difficult to obtain accurate distance information using known technology, because an apparatus (e.g., an image sensor) for sensing infrared rays has poor infrared detection ability and a high signal-to-noise ratio (SNR) in a process of obtaining distance information. That is, it may be difficult to implement a high-quality 3D image due to difficulties in obtaining high-quality distance information.

Accordingly, the following embodiments of the present invention provide a 3D image sensor module that may implement a high-quality 3D image and a method of generating a 3D image using the same. To this end, a variable filter is included in a 3D image sensor module. The variable filter may separate visible rays and infrared rays from incident light in a time-division way. By using a time-division way, the variable filter may cut off (or filter out) infrared rays that act as noise in a process of obtaining image information, and block visible rays that act as noise in a process of obtaining distance information.

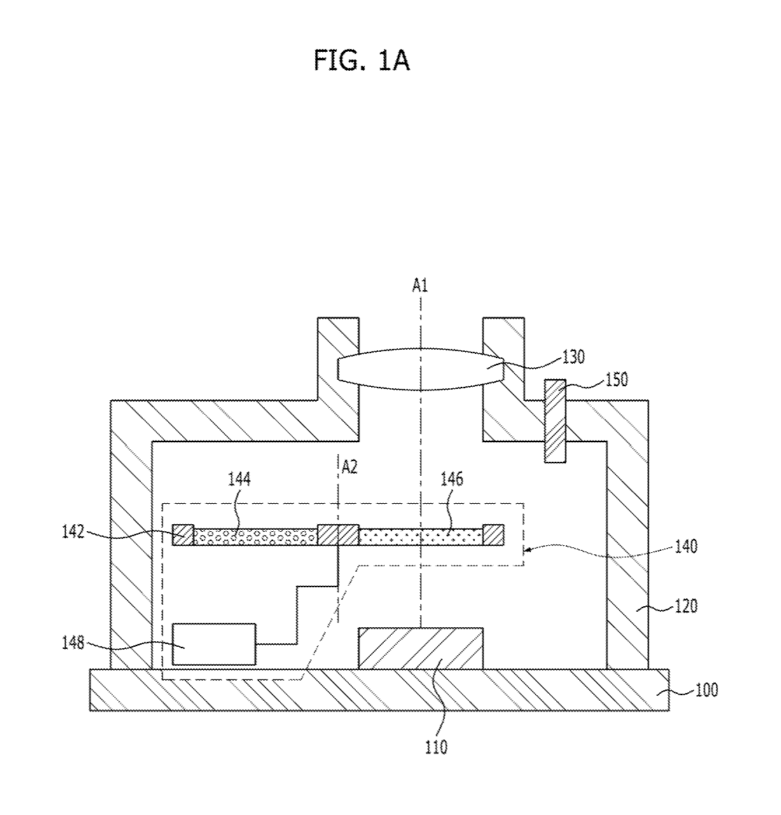

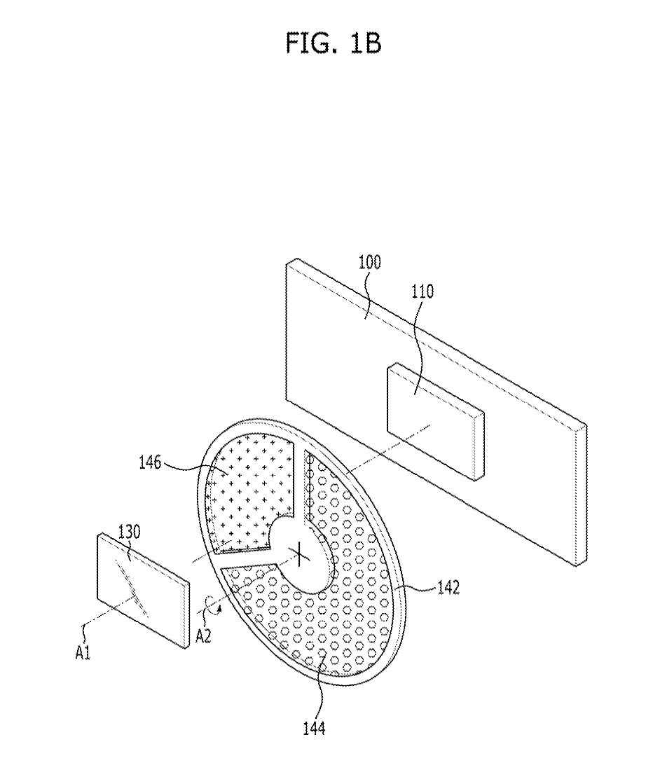

FIG. 1A is a cross-sectional view illustrating the 3D image sensor module in accordance with an embodiment of the present invention, and FIG. 1B is a perspective view illustrating some of the elements of the 3D image sensor module shown in FIG. 1A. FIG. 2 is a perspective view illustrating the 3D image sensor module in accordance with a modified embodiment of the present invention.

As shown in FIGS. 1A and 1B, the 3D image sensor module may include a support substrate 100, an image sensor 110, a housing 120, a lens 130, a variable filter 140, and a light source 150. Here, the variable filter 140 may filter visible rays and infrared rays incident on the image sensor 110 in a time-division way, and a light source 150 capable of radiating infrared rays to a subject for photography.

The support substrate 100 is a part on which the image sensor 110 is mounted. The support substrate 100 may include a printed circuit board (PCB) or a flexible printed circuit board (FPCB). Although not shown, the support substrate 100 may include electrical interconnection (e.g., wiring) between elements of the 3D image sensor module, such as the image sensor 110, the variable filter 140, and the light source 150.

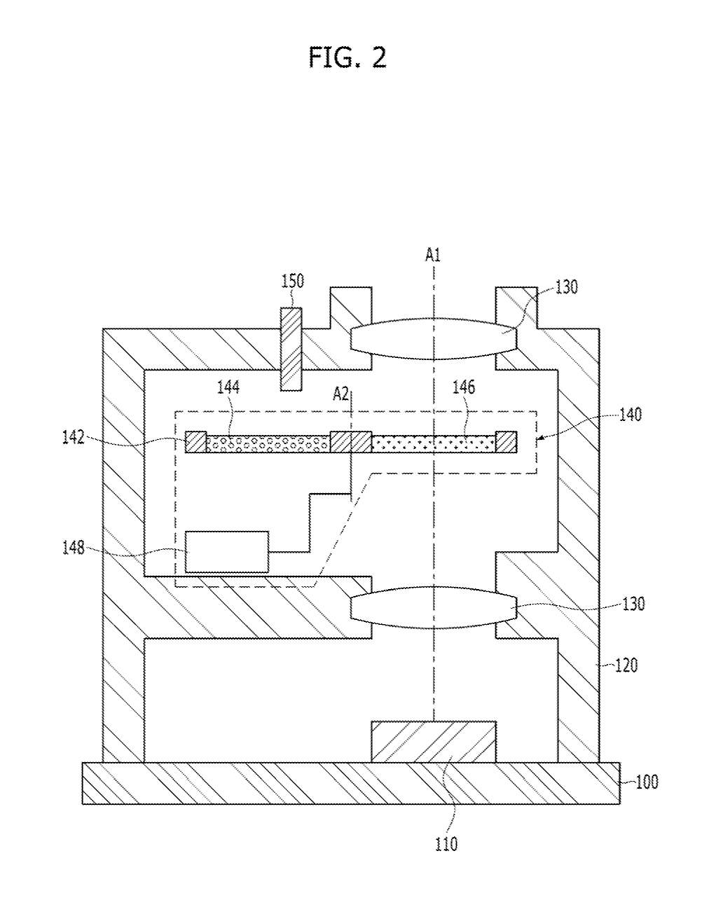

The image sensor 110 may function to convert an optical signal, including information on an image and distance (or depth) of a subject for photography, into an electrical signal. The image sensor 110 may include a plurality of color pixels for obtaining information on an image (or color) of a subject for photography based on visible rays reflected from the subject for photography and a plurality of infrared pixels for obtaining information on the distance from a subject for photography based on infrared rays reflected from the subject for photography. The image sensor 110 may include a charge-coupled device (CCD) or a CMOS image sensor (CIS). For reference, an example of the image sensor 110 in accordance with the embodiment is described in detail with reference to FIGS. 3A and 3B.

The housing 120 may function to provide a space in which the support substrate 100, the image sensor 110, the lens 130, the variable filter 140, and the light source 150 may be arranged. Furthermore, the housing 120 may function to protect the elements arranged therein from external alien substances or a shock.

The lens 130 may function to condense light incident on the 3D image sensor module into the image sensor 110. The housing 120 surrounds the image sensor 110 and the variable filter 140. The lens 130 may be disposed in the housing 120 and connected to the housing 120. The 3D image sensor module may include one or more the lenses 130. That is, the 3D image sensor module may include one lens 130 (referring to FIG. 1A) or a plurality of lenses 130 (referring to FIG. 2). For example, the lens 130 may be a variable focus liquid crystal lens. For reference, the variable focus liquid crystal lens is a lens using a refractive index that varies depending on a change in the orientation of liquid crystal molecules. Such a lens may change its focal distance by controlling voltage applied to both terminals of the lens.

The variable filter 140 may function to filter visible rays and infrared rays from light incident on the image sensor 110 in a time-division way. That is, the variable filter 140 functions to transmit visible rays or infrared rays that are included in incident light selectively and sequentially and transfer the transmitted light to the image sensor 110. To this end, the variable filter 140 may include a first filtering unit for transmitting visible rays and cutting off (or filtering out) infrared rays and a second filtering unit for cutting off visible rays and transmitting infrared rays. The first filtering unit may include an infrared (IR) cut filter 144, and the second filter may include an infrared (IR) pass filter 146. The variable filter 140 may further include a frame 142 to which the IR cut filter 144 and the IR pass filter 146 are fixed and driving unit 148 connected to the frame 142 and configured to rotate the frame 142 so that the IR cut filter 144 or the IR pass filter 146 is placed over the image sensor 110. If the IR cut filter 144 is placed in an incident light axis A1 when the image sensor 110 obtains image information using visible rays, high-quality image information may be obtained, because infrared rays acting as noise when obtaining the image information is cut off. In contrast, if the IR pass filter 146 is placed in the incident light axis A1 when the image sensor 110 obtains distance information using infrared rays, high-quality distance information may be obtained, because visible rays acting as noise when obtaining the distance information is cut off.

The variable filter 140 may be disposed between the lens 130 and the image sensor 110 (referring to, FIG. 1A) or between the plurality of lenses 130 (referring to, FIG. 2). A position of the variable filter 140 may be changed according to a characteristic required to the 3D image sensor module.

An area of the IR pass filter 146 and the IR cut filter 144 occupied in the variable filter 140 may be controlled depending on an area of color pixels that respond to visible rays and of infrared pixels that respond to infrared rays in the image sensor 110. More particularly, an area ratio of the IR pass filter 146 to the IR cut filter 144 may be proportional to an area ratio of color pixels to infrared pixels. For example, if an area ratio of color pixels (refer to R, G, B in FIG. 3B) to infrared pixels (refer to IR in FIG. 3B) in a unit pixel group (refer to 115 in FIGS. 3A and 3B) is 1 to 3, an area ratio of the IR pass filter 146 to the IR cut filter may be 1N to 3N. Here, N is a natural number.

The frame 142 may have a rotation center axis A2 parallel to the incident light axis A1 and may rotate around the rotation center axis A2. The frame 142 may have a wheel shape to provide visible rays and infrared rays from incident light to the image sensor 110 in a time-division way. Part of the frame 142 may be placed in the incident light axis A1. Part of the frame 142 may selectively place the IR pass filter 146 and the IR cut filter 144, fixed to the frame 142 and configured to enter the image sensor 110 as the driving unit 148 rotates the frame 142, in the incident light axis A1.

The driving unit 148 functions to control a movement of the frame 142 and may include various known actuators, such as a servo motor and a voice coil motor (VCM). The driving unit 148 may further include transfer unit (e.g., a gear system (not shown)) for transferring driving force of the various actuators to the frame 142.

The light source 150 functions to radiate infrared rays to a subject for photography. The light source 150 may be used if infrared rays necessary to obtain distance information from incident light are insufficient. The light source 150 may also be used as lighting for obtaining a clear image in a room having insufficient lighting or at night.

The 3D image sensor module including the variable filter 140 may implement a high-quality 3D image by excluding optical signals acting as noise in a process of obtaining image information and distance information, respectively, for implementing a 3D image and obtaining high-quality image information and high-quality distance information.

An example of an image sensor, which may be applied to the 3D image sensor module in accordance with the embodiment, is described below. More particularly, an example in which a CMOS image sensor (CIS) is applied to the 3D image sensor module is described below with reference to FIGS. 3A and 3B.

FIGS. 3A and 3B are diagrams showing an image sensor in accordance with an embodiment of the present invention. More particularly, FIG. 3A is a schematic diagram of the image sensor, and FIG. 3B is a schematic diagram of a pixel array within the image sensor.

As shown in FIGS. 3A and 3B, the image sensor 110 in accordance with the embodiment may include a pixel array 111, a row driver 112, a correlated double sampling (CDS) block 113, an analog digital converter (ADC) block 114, a ramp generator 116, a timing generator 117, a control register block 118, and a buffer 119. A timing signal generated from the timing generator 117 is provided to the image sensor 110, the variable filter 140, and the light source 150 and may be used to control the image sensor 110, the variable filter 140, and the light source 150.

The pixel array 111 may include a plurality of unit pixel groups 115 arranged in a 2D manner, and each of the unit pixel groups 115 may include a plurality of pixels. More particularly, the unit pixel group 115 may include a plurality of color pixels R, G, B for obtaining information on an image (or color) of a subject for photography and one or more infrared pixels IR for obtaining information on the distance of a subject for photography. For example, the unit pixel group 115 may include four pixels that include a red pixel R, a green pixel G, a blue pixel B, and an infrared pixel IR.

The color pixels R, G, B may include a photo detection region in which photo charges generated from visible rays are collected, and the infrared pixel IR may include a photo detection region in which photo charges generated from infrared rays (or near-infrared rays) are collected. The photo detection region may include a photodiode. The infrared pixel IR may include a photodiode having a deeper depth than the color pixels R, G, B so that photo charges are efficiently generated from infrared rays (or near-infrared rays) having a longer wavelength than visible rays. Accordingly, quantum efficiency (QE) of the infrared pixel IR may be improved.

Image information and distance information may be easily obtained through one image sensor 110, because the pixel array 111 includes the color pixels R, G, B and the infrared pixels IR. As a result, the size of the 3D image sensor module may be significantly reduced.

A method of generating a 3D image using the 3D image sensor module in accordance with the embodiment is described in detail below with reference to FIGS. 1A, 1B, 2, 3A, 3B, and 4. The same reference numerals as those of the elements of the 3D image sensor module described above are used below.

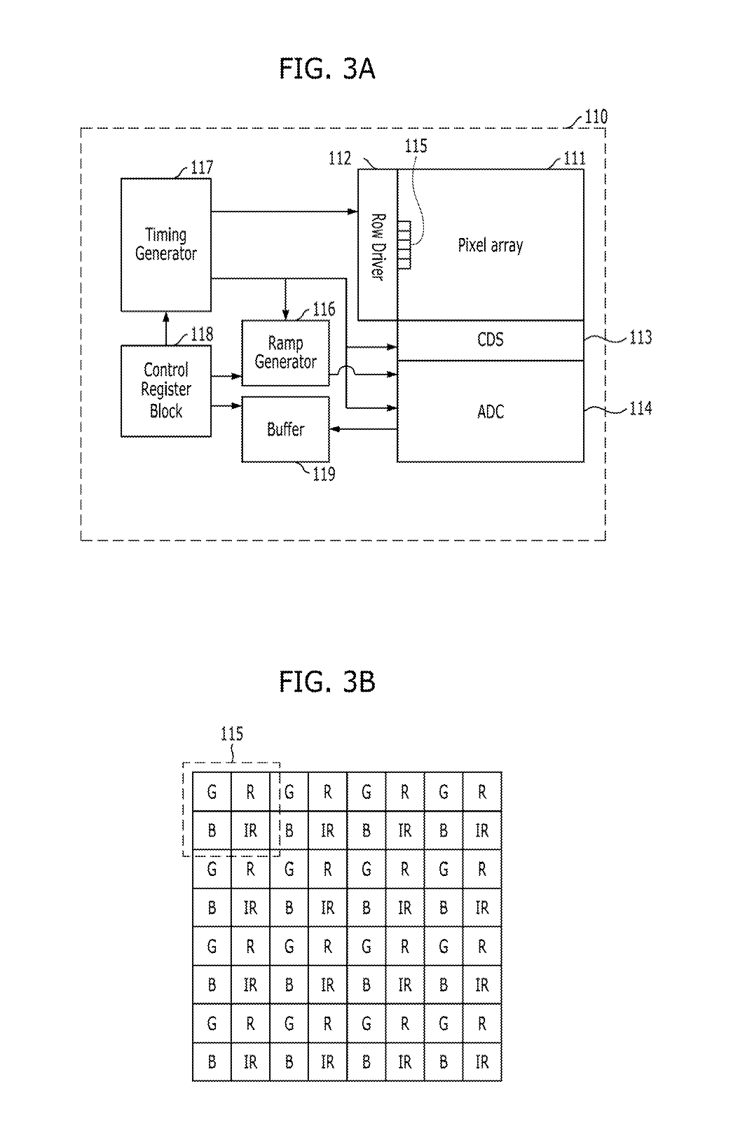

FIG. 4 is a flowchart illustrating the method of generating a 3D image using the 3D image sensor module in accordance with the present embodiment.

As shown in FIG. 4, the 3D image sensor module in accordance with the embodiment may implement a 3D stop image and a 3D motion image. Accordingly, the 3D image sensor module determines whether a 3D image to be implemented is a stop image or a 3D motion image at step S101.

First, a method of generating a 3D stop image is described below.

The variable filter 140 is rotated so that the IR cut filter 144 is placed in the incident light axis A1 at step S201. The variable filter 140 may be rotated by controlling the driving unit 148, and the driving unit 148 may be controlled in response to the timing signal generated from the timing generator 117 of the image sensor 110.

Next, image information is obtained from visible rays filtered by the IR cut filter 144 using the color pixels R, G, B of the image sensor 110 at step S202. Here, the generation of noise in the color pixels R, G, B, which is attributable to infrared rays, may be prevented, because the IR cut filter 144 prevents the infrared rays from entering the image sensor 110. Furthermore, the image information is not affected by noise although the noise is generated due to visible rays in the infrared pixels IR, because the color pixels R, G, B and the infrared pixels IR are separated in the image sensor 110. The image information obtained through the color pixels R, G, B may be stored in the buffer 119 for a specific time.

Next, the variable filter 140 is rotated so that the IR pass filter 146 is placed in the incident light axis A1 at step S203. The variable filter 140 may be rotated by controlling the driving unit 148. The driving unit 148 may be controlled in response to the timing signal generated from the timing generator 117 of the image sensor 110.

Next, distance information is obtained from infrared rays filtered by the IR pass filter 146 using the infrared pixels IR of the image sensor 110 at step S204. Here, the generation of noise in the infrared pixels IR, which is attributable to visible rays, may be prevented, because the IR pass filter 146 prevents the visible rays from entering the image sensor 110. Furthermore, the distance information is not affected by noise although the noise is generated due to infrared rays in the color pixels R, G, B, because the color pixels R, G, B and the infrared pixels IR are separated in the image sensor 110. The image information obtained through the infrared pixels IR may be stored in the buffer 119 for a specific time.

A 3D stop image is implemented by adding up the image information and the distance information obtained from the buffer 119 at step S401. Various known methods may be used to implement a 3D image by adding up image information and distance information.

Second, a method of generating a 3D motion image is described below.

The variable filter 140 is rotated so that the IR cut filter 144 and the IR pass filter 146 continue to be placed in the incident light axis A1 alternately at step S301. Here, rotational speed (or a rotating amount) of the variable filter 140 may be controlled depending on frame per second (FPS) of a 3D motion image to be implemented. More particularly, the variable filter 140 may be rotated so that each of the IR cut filter 144 and the IR pass filter 146 is placed in the incident light axis A1 by an integer number times the FPS. For example, if the FPS is 24 (i.e., if 24 sheets of stop images are included in one second), each of the IR cut filter 144 and the IR pass filter 146 may be placed in the incident light axis A1 24N times (N is a natural number). The variable filter 140 may be rotated by controlling the driving unit 148, and the driving unit 148 may be controlled in response to the timing signal generated from the timing generator 117 of the image sensor 110.

Next, image information and distance information continue to be obtained from visible rays and infrared rays, entering the image sensor 110 in a time-division way, through the variable filter 140 that rotates based on the FPS at step S302. The image information and the distance information obtained using the color pixels R, G, B and the infrared pixels IR may be stored in the buffer 119 for a specific time.

That is, a 3D motion image may be implemented by a process of obtaining a plurality of pieces of image information and a plurality of pieces of distance information by sequentially performing steps S201 to S204.

Next, a 3D motion image is implemented by sequentially adding up the pieces of image information and the pieces of distance information sequentially obtained from the buffer 119 at step S401. Various known methods may be used to implement a 3D image by adding up image information and distance information.

In accordance with the method of generating a 3D image, a high-quality 3D image may be implemented using high-quality image information and high-quality distance information by excluding optical components that act as noise in a process of obtaining image information and distance information, respectively.

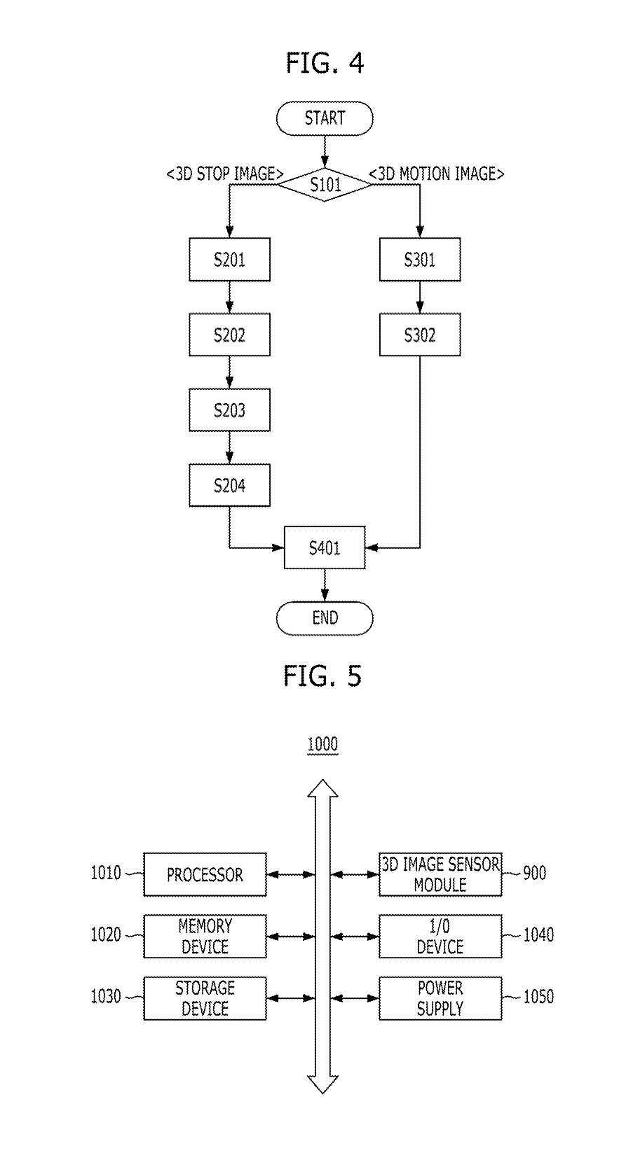

FIG. 5 is a schematic diagram of an image processing system including a 3D image sensor module in accordance with the embodiment of the present invention.

As shown in FIG. 5, the image processing system 1000 may include a processor 1010, a memory device 1020, a storage device 1030, an I/O device 1040, a power supply 1050, and a 3D image sensor module 900.

The processor 1010 may perform specific operations or tasks. In some embodiments, the processor 1010 may be a microprocessor or a central processing unit (CPU). The processor 1010 may perform communication with the memory device 1020, the storage device 1030, and the I/O device 1040 through an address bus, a control bus, and a data bus. In some embodiments, the processor 1010 may be coupled with an extension bus, such as a peripheral component interconnect (PCI) bus.

The memory device 1020 may store data for the operations of the image processing system 1000. For example, the memory device 1020 may be implemented using DRAM, mobile DRAM, SRAM, PRAM, FRAM, RRAM and/or MRAM (or STTRAM).

The storage device 1030 may include a solid-state drive (SSD), a hard disk drive and/or CD-ROM. The I/O device 1040 may include input means, such as a keyboard, a keypad, and a mouse, and output means, such as a printer and a display.

The power supply 1050 may supply operating voltages for the operations of the image processing system 1000.

The 3D image sensor module 900 may be the 3D image sensor module in accordance with the aforementioned embodiment. The 3D image sensor module 900 is coupled with the processor 1010 through the buses or other communication links, and the 3D image sensor module 900 may perform communication. The 3D image sensor module 900, together with the processor 1010, may be integrated into one chip, or the 3D image sensor module 900 and the processor 1010 may be integrated into different chips.

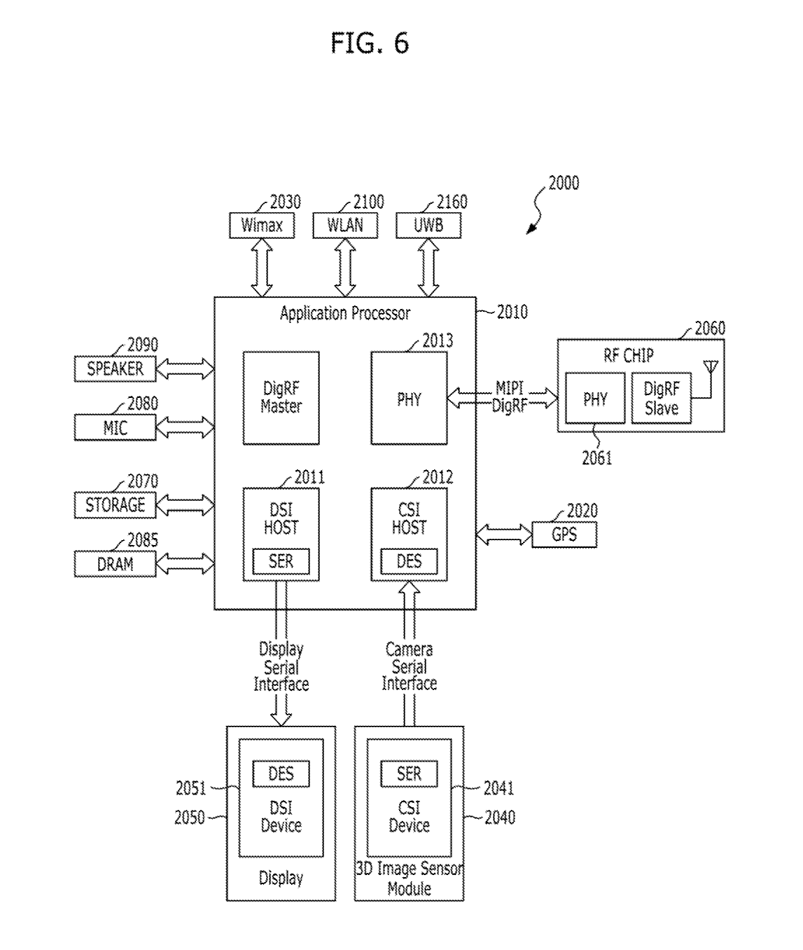

FIG. 6 is a schematic diagram of another image processing system including a 3D image sensor module in accordance with the embodiment of the present invention.

As shown in FIG. 6, the image processing system 2000 may be implemented as a data processing device capable of using or supporting a mobile industry processor interface (MIPI) interface, for example, a mobile communication device, such as a personal digital assistant (PDA), a portable media player (PMP), a mobile phone, or a smart phone. The image processing system 2000 may be implemented as a handheld device, such as a tablet computer.

The image processing system 2000 includes an application processor 2010, a 3D image sensor module 2040, and a display 2050.

A camera serial interface (CSI) host 2012 implemented in the application processor 2010 may perform serial communication with the CSI device 2041 of the 3D image sensor module 2040 through a CSI. Here, the 3D image sensor module 2040 may be the aforementioned 3D image sensor module in accordance with the present embodiment. A DSI host 2011 implemented in the application processor 2010 may perform serial communication with the display serial interface (DSI) device 2051 of the display 2050 through a DSI.

The image processing system 2000 may further include a radio frequency (RF) chip 2060 capable of communicating with the application processor 2010. The PHY 2013 of the application processor 2010 and the PHY 2061 of the RF chip 2060 may exchange data based on MIPI DigRF.

The image processing system 2000 may further include a global positioning system (GPS) 2020, a data storage device 2070, a microphone MIC 2080, memory 2085, such as DRAM, and a speaker 2090. The image processing system 2000 may perform communication using Wimax 2030, a wireless LAN (WLAN) 2100, and an ultra-wideband (UWB) 2110.

In accordance with the embodiments of the invention, a high-quality 3D image may be implemented using high-quality image information and high-quality distance information, because optical components acting as noise in a process of obtaining image information and distance information is removed, respectively, using the variable filter.

While the present invention has been described with respect to the specific embodiments, it will be apparent to those skilled in the art that various changes and modifications may be made without departing from the spirit and scope of the invention as defined in the following claims.

What is claimed is:

1. A three-dimensional (3D) image sensor module, comprising:
an image sensor including a plurality of color pixels and a plurality of infrared pixels; and
a variable filter suitable for filtering infrared rays from light, which is incident on the image sensor, in a time-division way.

2. The 3D image sensor module of claim 1, wherein the variable filter has a wheel shape suitable for rotating along a rotation center axis parallel to an incident light axis.

3. The 3D image sensor module of claim 1, wherein the variable filter comprises:
a wheel-shaped frame rotatable so that part of the frame is placed over the image sensor; and
driving unit suitable for rotating the wheel-shaped frame.

4. The 3D image sensor module of claim 1, wherein the image sensor further includes a timing generator suitable for generating a timing signal for controlling the variable filter.

5. The 3D image sensor module of claim 1, further comprising a light source suitable for radiating infrared rays to a subject for photography.

6. The 3D image sensor module of claim 1, further comprising:
a housing suitable for surrounding the image sensor and the variable filter; and
one or more lenses suitable for disposing in the housing and being connected to the housing,
wherein the variable filter is placed between the lens and the image sensor or between the lenses.

7. A three-dimensional (3D) image sensor module, comprising:
an image sensor including a plurality of color pixels and a plurality of infrared pixels; and
a variable filter including a first filtering unit suitable for filtering out infrared rays from a incident light, a second filtering unit suitable for filtering out visible rays from the incident light, and a driving unit suitable for selectively and sequentially placing the first filtering unit and the second filtering unit over the image sensor.

8. The 3D image sensor module of claim 7, wherein:
the first filtering unit and the second filtering unit are fixed to a wheel-shaped frame, and
the driving unit rotates the wheel-shaped frame along a rotation center axis parallel to an incident light axis.

9. The 3D image sensor module of claim 7, wherein an area ratio of the first filtering unit to the second filtering unit occupied in the variable filter is proportional to an area ratio of color pixels to infrared pixels occupied in the image sensor.

10. The 3D image sensor module of claim 7, wherein:
the image sensor further includes a timing generator suitable for generating a timing signal for controlling the variable filter.

11. The 3D image sensor module of claim 7, further comprising a light source suitable for radiating infrared rays to a subject for photography.

12. A method of generating a three-dimensional (3D) image using a variable filter including a first filtering unit suitable for filtering out infrared rays from a incident light and a second filtering unit suitable for filtering out visible rays from the incident light, the method comprising:
placing the first filtering unit over the image sensor;
obtaining image information on a subject for photography by using the incident light filtered through the first filtering unit;
placing the second filtering unit over the image sensor; and
obtaining distance information on the subject for photography by using the incident light filtered through the second filter.

13. The method of claim 12, further comprising:
generating a 3D stop image by using the image information and the distance information.

14. The method of claim 13, further comprising:
generating a 3D motion image by using a plurality of pieces of the image information and a plurality of pieces of the distance information.

15. The method of claim 14, wherein a number of times that the first filter or the second filter is placed over the image sensor is proportional to an integer number times a frame per second (FPS) of the 3D motion image.

16. The method of claim 12, wherein the first filtering unit and the second filtering unit are fixed to a wheel-shaped frame.

17. The method of claim 15, wherein the variable filter further includes a driving unit suitable for rotating the wheel-shaped frame along a rotation center axis parallel to an incident light axis.
